(19) United States
(12) Patent Application Publication
(10) Pub. No.: US 2026/0252336 A1
(43) Pub. Date: Aug. 27, 2026

(54) PROACTIVE FIRMWARE RUNTIME SERVICE TO MITIGATE BOOT FAILURES

(71) Applicant: DELL PRODUCTS L.P., Round Rock, TX (US)

(72) Inventors: Venkata Rama Krishna Rao Atta, Hyderabad (IN); Ibrahim Sayyed, Georgetown, TX (US); Adolfo Montero, Pflugerville, TX (US)

(21) Appl. No.: 19/064,386

(22) Filed: Feb. 26, 2025

(51) Int. Cl. G06F 8/65

(52) U.S. Cl. CPC G06F 8/65

(57) ABSTRACT

An information handling system includes a host environment and a baseboard management controller. The host environment provides a firmware update for the information handling system. The baseboard management controller receives firmware update information related to the firmware update from the host environment, compares the firmware update information to a firmware registry to determine if the firmware update is validated, and reboots the information handling system in a recovery mode when the firmware update is not validated.

### FIELD OF THE DISCLOSURE

This disclosure relates to information handling systems, and more particularly relates to providing proactive firmware runtime services to mitigate boot failures from third party firmware changes in an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may include a host environment and a baseboard management controller. The host environment may provide a firmware update for the information handling system. The baseboard management controller may receive firmware update information related to the firmware update from the host environment, compare the firmware update information to a firmware registry to determine if the firmware update is validated, and reboot the information handling system in a recovery mode when the firmware update is not validated.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an information handling system according to an embodiment of the present disclosure;

FIG. 2 illustrates the information handling system of FIG. 1 and a method for providing proactive firmware runtime services to mitigate boot failures from third party firmware changes; and

FIG. 3 is a block diagram illustrating a generalized information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

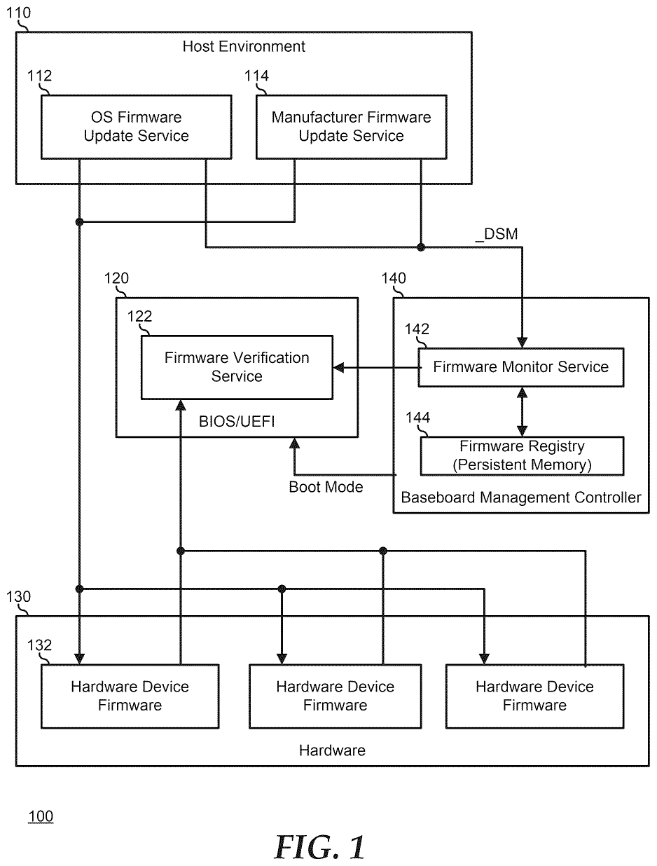

FIG. 1 illustrates an information handling system 100 including a host environment 110, a Basic Input/Output System/Universal Extensible Firmware Interface (BIOS/UEFI) 120, hardware devices 130, and a Baseboard Management Controller (BMC) 140. Host environment 110 represents a processing environment instantiated on a processor of information handling system 100, such as a CPU or the like, that operates to provide the processing functions and features typically associated with the information handling system. As such, host environment 110 may be representative of a processing environment established by an operating system (OS) instantiated on the processor, such as a Windows OS, a Linux OS, or the like. Host environment 110 includes an OS-based firmware update service 112 and a manufacturer-based firmware update service 114, as described further below.

BIOS/UEFI 220 represents code instantiated on the processor that operates to detect hardware and firmware resources within information handling system 100, to provide drivers for the resources, to initialize the resources, and to access the resources. Such resources include hardware elements 130. BIOS/UEFI 220 includes a firmware verification service 122, as described further below.

Hardware devices 130 represent various hardware devices provided on information handling system 100. Such hardware devices may include hardware devices that are provided on information handling system 100 by a manufacturer of the information handling system, and may include Non-Volatile Memory Express (NVME) storage devices, network interface devices such as a network interface card (NIC) or host bus adaptor (HBA), a video or graphics processor device such as a graphics processing unit (GPU), or other hardware devices as needed or desired. the hardware devices may further include various hardware devices that are added into information handling system 100 by a user of the information handling system. Such user-added hardware devices may include additional NVME storages devices, a user-preferred NIC or GPU, or the like. Hardware elements 130 includes a hardware device 132 and one or more additional hardware device. Hardware device 132 includes firmware that represents code, such as device drivers, that permit host environment 110 and BIOS/UEFI 120 to initialize and access the hardware device.

BMC 140 represents a management environment instantiated on a service processor of information handling system 100 that permit the out-of-band (OOB) monitoring, management, and maintenance of the elements of the information handling system. As such, BMC 140 represents hardware elements and firmware elements that operate as described further herein. BMC 140 includes a firmware monitor service 142 and a firmware registry 144, as described further below.

When information handling system 100 is manufactured, the manufacturer typically installs manufacturer-based firmware update service 114. Here the manufacturer is aware of the hardware devices 130 that are factory installed into information handling system 100, and the manufacturer tracks the firmware updates provided by the original equipment manufacturers (OEMs) for the factory installed hardware devices. The manufacturer typically ensures that any such firmware updates are reliable and that updating the firmware of hardware devices 130 does not result in any instability in information handling system 100, such as boot failures, operating failures, or the like, before releasing the firmware updates to the information handling system. In this regard, manufacturer-based firmware update service 114 is connected to a manufacturer site that manages the firmware updates on information handling system 100 and operates to download and install the vetted firmware updates on the information handling system as they become available. If a particular firmware update fails the manufacture's vetting process, the manufacturer can typically notify the OEM of the problem and obtain a new firmware update before releasing the firmware update to manufacturer-based firmware update service 114. In this way, a manufacturer may manage the reliability of their products and assure the stability of information handling system 100.

When an OS is instantiated on information handling system 100, the OS typically includes OS-based firmware update service 112. OS-based firmware update service 112 is similar to manufacturer-based firmware update service 114, in that the developer of the OS is typically aware of the firmware updates that are available for hardware devices 130 of information handling system 100. In particular, the OS may operate to detect the various devices of hardware devices 130 and OS-based firmware update service 112 operates to obtain the firmware updates for the detected devices and the install the firmware updates. However, the OS developer may not typically perform as detailed a vetting process as the manufacturer. Thus, in the interest of timely updates, the OS developer may push out an instable firmware update, or an update that conflicts with the manufacturer-installed hardware devices, causing instability in information handling system 100. In other cases, the OS developer may be unaware of incompatibilities between manufacturer-installed hardware devices and user-installed hardware devices, and may thus cause boot or runtime failures in information handling system 100.

In a particular embodiment, information handling system 100 operates to monitor and manage the implementation of firmware updates as performed by OS-based firmware update service 112. In particular, when OS-based firmware update service 112 provides a firmware update to hardware device firmware 132, the OS-based firmware update service operates to send information to firmware monitor service 142 related to the firmware update. Firmware monitor service 142 then operates to compile firmware registry 144 that includes the current status of all firmware instantiated on information handling system 100. Similarly, manufacturer-based firmware update service 114 provides information to firmware monitor service 142 related to the manufacturer-verified firmware updates on information handling system 100. Here, firmware monitor service 142 operates to include the manufacturer-verified firmware update information in firmware registry 144.

OS-based firmware update service 112 and manufacturer-based firmware update service 114 may provide information to firmware monitor service 142 through the use of a Device Specific Method (_DSM) command that permits the bridging between host environment 110 and BMC 140. Here, BIOS/UEFI 120 operates to define an Advanced Configuration and Power Interface (ACPI) function associated with the tracking of firmware updates and providing the update information to firmware update monitor 142. The _DSM command may include such information related to the particular firmware update as a device vendor name, a vendor identifier, a device type, a device identifier, a firmware version identifier, a device driver identifier, or the like. Examples of a _DSM update start command may be provided as follows:
Function 1:3rdParty_Vendor_Update_Start
   Arg0: UUID=3c2067e3-887d-475c-9720-4af1d3ed604f
   Arg1: Revision=0
   Arg2: Function index=1
   Arg4: Parameters {VendorName, deviceId, vendorId, devciepath, fw version, driver version . . . etc}
      and a _DSM update end command may be provided as follows:
Function 2:3rdParty_Vendor_Update_End
   Arg0: UUID=6c2067e3-887d-475c-9720-4af1d3ed603f
   Arg1: Revision=0
   Arg2: Function index=2.
      The details of providing _DSM commands within an ACPI function are known in the art and will not be further described herein, except as may be needed to illustrate the current embodiments.

When OS-based firmware update service 112 provides a firmware update, and provides the firmware update message to firmware monitor service 142, the firmware monitor service compares the information related to the firmware update with the list of manufacturer-verified firmware updates stored in firmware registry 144. If the firmware update information indicates that the firmware update is consistent with the manufacturer-verified firmware updates, then no further action needs to be taken with regard to the firmware update provided by OS-based firmware update service 112.

In a particular embodiment, if the firmware update information indicates that the firmware update is not consistent with the manufacturer-verified firmware updates, firmware monitor service 142 directs firmware verification service 122 to verify the boot status of the firmware update. In a particular case, this is done by directing BIOS/UEFI 120 to perform a boot of information handling system 100 in a boot mode that invokes firmware verification service 122. Firmware verification service 122 operates to monitor the boot process to identify issues with the boot process, such as device failure to initialize, boot path failure, or the like. If no issues with the boot process are identified, firmware verification service 122 operates to permit the boot process to proceed with the firmware update, in spite of the fact that the firmware update is not a manufacturer-verified firmware update.

In another embodiment, firmware verification service 122 operates to compare the list of manufacturer-verified firmware updates from firmware registry 144 with the firmware to be booted by BIOS/UEFI 120. If the firmware update information indicates that the firmware update is consistent with the manufacturer-verified firmware updates, then firmware verification service 122 updates firmware registry 144 with the newly installed firmware update, and firmware verification service 142 permits the boot process to proceed normally. On the other hand, if the firmware update information indicates that the firmware update is not consistent with the manufacturer-verified firmware updates, then firmware monitor service 142 provides an indication that the firmware update is not compatible with information handling system 100 and proceeds to reboot information handling system 100 with in alternative boot mode or with an alternate path, such as by booting the information handling system to a safe mode or to a recovery OS or OEM SOS boot mode to revert back to a prior version of the firmware update, as needed or desired. If all such boot modes fail to correct the problem with the firmware update, firmware verification service 122 operates to reset the relevant firmware back to a factory default mode and reboots to the OS. Once information handling system 100 is successfully booted to the OS, BMC 140 operates to notify the OS with suggestive actions to remediate the issue with the firmware update, as needed or desired.

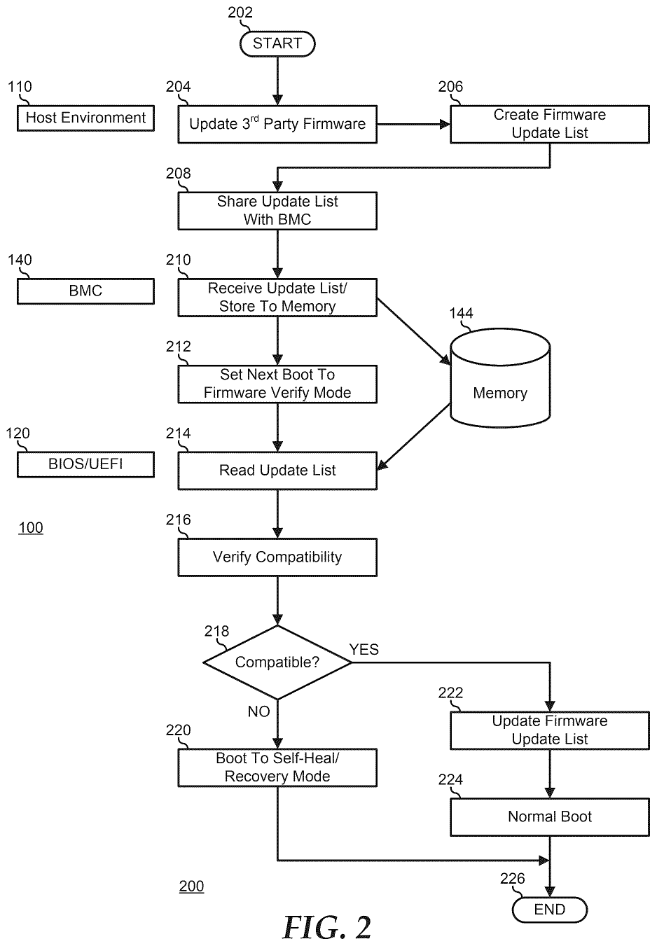

FIG. 2 illustrates information handling system 100 and a method 200 for providing a proactive firmware runtime services to mitigate boot failures from third party firmware changes, starting at block 202. In block 204, host environment 110 updates a third party firmware, and creates a firmware update list in block 206. Host environment 110 then shares the firmware update list with BMC 140 in block 208. BMC 140 receives the firmware update list and stores the firmware update list to a memory device 144 in block 210. BMC 140 sets a next boot to enter a firmware verity mode in block 212.

In block 214, BIOS/UEFI 120 reads the firmware update list from memory device 144, and verifies the compatibility of the firmware update in block 216. A decision is made as to whether or not the firmware update is compatible with the firmware update list in decision block 218. If not, the “NO” branch of decision block 218 is taken, BIOS/UEFI 120 reboots information handling system 100 in a self-heal/recovery mode in block 220 and the method ends in block 226. If the firmware update is compatible with the firmware update list, the “YES” branch of decision block 218 is taken, the firmware update list is updated in block 222, information handling system 100 is rebooted normally in block 224, and the method ends in block 226.

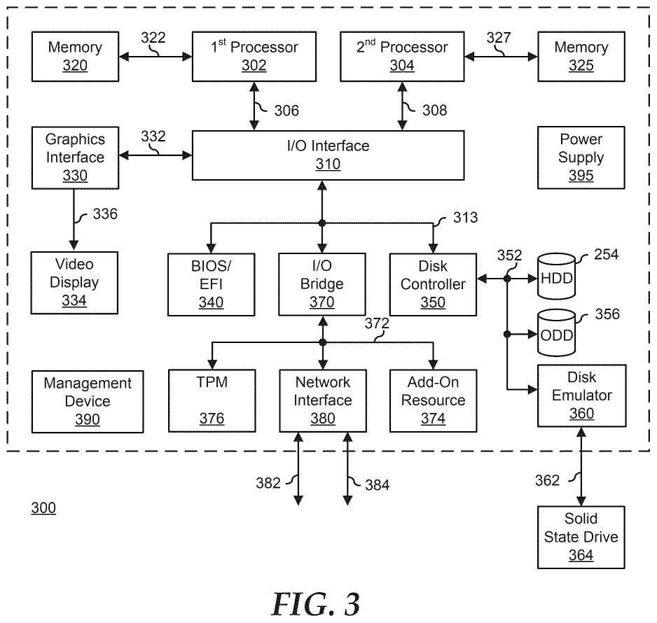

FIG. 3 illustrates a generalized embodiment of an information handling system 300 similar to information handling system 300. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below, and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 362, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 362, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332, and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 1394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312, or can be a different type of interface. As such, I/O bridge 370 extends the capacity of I/O channel 312 where peripheral interface 372 and the I/O channel are of the same type, and the I/O bridge translates information from a format suitable to the I/O channel to a format suitable to the peripheral channel 372 where they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300. Management device 390 can operate off of a separate power plane from the components of the host environment so that the management device receives power to manage information handling system 300 where the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed:

1. An information handling system, comprising:
a host environment instantiated on the information handling system, the host environment configured to provide a firmware update for the information handling system;
a baseboard management controller (BMC) configured to receive firmware update information related to the firmware update from the host environment, to compare the firmware update information to a firmware registry to determine if the firmware update is validated, and to reboot the information handling system in a recovery mode when the firmware update is not validated.

2. The information handling system of claim 1, wherein the host environment includes an operating system firmware update service configured to provide firmware updates and a manufacturer firmware update service configured to provide the firmware updates.

3. The information handling system of claim 2, wherein the BMC is further configured to determine whether the firmware update information is received from the operating system firmware update service or the manufacturer firmware update service.

4. The information handling system of claim 3, wherein the firmware update is validated when the firmware update is received from the manufacturer firmware update service.

5. The information handling system of claim 4, wherein the BMC is further configured to update the firmware registry with the firmware update information when the firmware update is received form the manufacturer firmware update service.

6. The information handling system of claim 3, wherein the firmware update is not validated when the firmware update is received from the operating system firmware update service.

7. The information handling system of claim 1, wherein, when the information handling system is rebooted in the recovery mode, the information handling system rolls back the firmware update to a previous version of firmware.

8. The information handling system of claim 1, wherein when the information handling system is rebooted in the recovery mode, the information handling system restores a default version of firmware.

9. The information handling system of claim 1, wherein the host environment is further configured to provide the firmware update information to the BMC.

10. The information handling system of claim 9, wherein in providing the firmware update information to the BMC, the host environment is further configured to provide an Advanced Configuration and Power Interface (ACPI) Device Specific Method (DSM) command to the BMC.

11. A method, comprising:
instantiating, on an information handling system, a host environment;
providing, by the host environment, a firmware update for the information handling system;
providing, on the information handling system, a baseboard management controller (BMC);
receiving, by the BMC, firmware update information related to the firmware update from the host environment;
comparing the firmware update information to a firmware registry to determine if the firmware update is validated; and
rebooting the information handling system in a recovery mode when the firmware update is not validated.

12. The method of claim 11, further comprising:
providing, in the host environment, an operating system firmware update service and a manufacturer firmware update service each configured to provide the firmware updates.

13. The method of claim 12, further comprising determining, by the BMC, whether the firmware update information is received from the operating system firmware update service or the manufacturer firmware update service.

14. The method of claim 13, wherein the firmware update is validated when the firmware update is received from the manufacturer firmware update service.

15. The method of claim 14, further comprising updating, by the BMC, the firmware registry with the firmware update information when the firmware update is received form the manufacturer firmware update service.

16. The method of claim 13, wherein the firmware update is not validated when the firmware update is received from the operating system firmware update service.

17. The method of claim 11, wherein, when the information handling system is rebooted in the recovery mode, the information handling system rolls back the firmware update to a previous version of firmware.

18. The method of claim 11, wherein, when the information handling system is rebooted in the recovery mode, the information handling system restores a default version of firmware.

19. The method of claim 11, further comprising providing, by the host environment, the firmware update information to the BMC.

20. An information handling system, comprising:
a host environment configured to provide a firmware update for the information handling system;
a baseboard management controller configured to receive firmware update information related to the firmware update from the host environment, and to store a firmware registry; and
a basic input/output system configured to compare the firmware update information to a firmware registry to determine if the firmware update is validated, and to reboot the information handling system in a recovery mode when the firmware update is not validated.
